(19) United States
(12) Patent Application Publication
(10) Pub. No.: US 2021/0003170 A1
(43) Pub. Date: Jan. 7, 2021

(54) MAGNETIC IMPULSE RING, BEARING UNIT AND ROTARY ELECTRICAL MACHINE COMPRISING A MAGNETIC IMPULSE RING, AND METHOD TO OBTAIN A MAGNETIC IMPULSE RING

(71) Applicant: Aktiebolaget SKF, Goteborg (SE)

(72) Inventors: Ananda Kumar Doddi, Bangalore (IN); Mathieu Hubert, Torino (FR)

(21) Appl. No.: 16/897,235

(22) Filed: Jun. 9, 2020

(30) Foreign Application Priority Data
Jul. 3, 2019 (IT) 102019000010791

(51) Int. Cl. F16C 19/16; F16C 33/58

(52) U.S. Cl. CPC F16C 19/16; F16C 2233/00; F16C 33/581

(57) ABSTRACT

A magnetic impulse ring having a central axis that includes a target holder and a target that is fixed to the target holder. The target provides a plurality of alternating South and North magnetic poles. The target is adapted to cooperate with magnetic detection means for tracking the rotation of the magnetic impulse ring around its central axis. The Total Pitch Deviation (TPD) of the magnetic impulse ring is less than or equal to 0.5%.

### CROSS-REFERENCE TO RELATED APPLICATIONS

This application claims priority to Italian Patent Application no. 102019000010791, filed Jul. 3, 2019, the contents of which is fully incorporated herein by reference.

### TECHNICAL FIELD OF THE INVENTION

The invention relates to a magnetic impulse ring. The invention also relates also to a bearing unit having a magnetic impulse ring. The invention also relates also to a rotary electrical machine comprising a magnetic impulse ring. The invention finally relates to a method to obtain a magnetic impulse ring.

### BACKGROUND OF THE INVENTION

Today, magnetic impulse rings comprising a plurality of alternating North and South magnetic poles are commonly used in various technical areas such as automotive, aeronautics and other industrial applications.

Magnetic detection means are arranged so as to face the magnetic impulse ring.

A conventional rotary electrical machine comprising a stator and a rotor is sometimes equipped with a magnetic impulse ring fixed to the rotor, and with a detection means in order to track and/or control the angular position of the rotor with respect to the stator. Such impulse ring and a rotary electrical machine are known from e.g. FR-A1-2 884 367.

However, due to manufacturing and magnetization constraints, the North and South poles of the magnetic impulse rings are not exactly all the same, from a geometrical and a magnetic point of view, which leads to measurement and control errors.

Improvements are still possible.

### SUMMARY OF THE INVENTION

The aim of the invention is to provide a magnetic impulse ring with a central axis and comprising a target holder and a target that is fixed to the target holder. The target is adapted to cooperate with magnetic detection means for tracking the rotation of the impulse ring around its central axis. The target comprises a plurality of alternating South and North magnetic poles. According to the invention, the Total Pitch Deviation of the magnetic impulse ring is smaller than or equal to 0.5%.

According to further aspects of the invention which are advantageous but not compulsory, such a magnetic impulse ring may incorporate one or several of the following features:

the target comprises anilco or ferrite or rare earth powder embedded in a matrix of resin or plastic or rubber material;

the target holder is made from a ferromagnetic material such as SPPCC or SUS 430.

Another object of the invention is a bearing unit comprising an inner ring, an outer ring, and a magnetic impulse ring according to the invention. The inner and outer rings are centered on the central axis of the impulse ring, and the impulse ring is fixed in rotation with the inner ring or the outer ring.

According to further aspects of the invention which are advantageous but not compulsory, such a bearing unit may incorporate one or several of the following features:

At least one row of rolling elements is arranged between the inner and outer rings;

The target holder comprises an outer tubular portion which extends parallel to the central axis of the impulse ring and which is located radially above the outer ring, the impulse ring being fixed in rotation with the inner ring.

Another object of the invention is an electric rotary machine comprising a stator, a rotor, detection means, and a magnetic impulse ring according to the invention and fixed in rotation with the rotor. The detection means are associated with the impulse ring for tracking the rotation of the rotor. The magnetic impulse ring is used to control the rotational position of the rotor with respect to the stator.

According to further aspects of the invention which are advantageous but not compulsory, such an electric rotary machine may incorporate one or several of the following features:

The detections means comprise a Hall effect cell or a Magneto-resistive cell;

The machine is an electric motor or a starter-alternator for a vehicle;

The machine comprises a bearing for supporting in rotation the rotor with respect to the stator, the bearing comprising an inner ring and an outer ring, the magnetic impulse ring being fixed in rotation with the inner ring or the outer ring of the bearing.

According to another aspect of the invention, a method to obtain a magnetic impulse ring according to the invention comprises several steps including the following ones:

(100) Molding a target made from magnetizable material on a target holder to obtain a target ring, then

(200) Machining an outer diameter of the target ring in order to improve the circularity of the outer diameter with respect to the central axis, then

(300) Magnetizing the target ring thanks to a magnetization device so as to form a plurality of magnetic poles pairs formed in the target.

In a preferred embodiment, the magnetization device has a tool comprising a mandrel rotatable around an axis, a magnetizing yoke, a support and a jig, the target ring being hold tight between the support and the jig during magnetization, and the jig has a tapered annular surface which, by contact with the target ring, centers accurately the target ring onto the rotation axis of the mandrel.

Thanks to the invention, the error on the angular position of the magnetic impulse ring, and therefore of the rotor of the rotary electric machine is reduced, and the performance of the machine is enhanced.

Thanks to the invention, the magnetization of the magnetic impulse ring is improved.

Thanks to the invention, when the rotary electrical machine is connected to an electrical power source and operates in such a way as selectively consume or restore electrical energy from or to the source, electrical oscillations are reduced. In particular, when the rotary electrical machine is a starter-alternator connected to a battery of a vehicle and is operated together with an internal combustion engine in a hybrid traction system, the level of CO2 emissions is reduced.

### BRIEF DESCRIPTION OF THE DRAWINGS

The invention will now be explained in correspondence with the annexed figures, as illustrative examples, without restricting the object of the invention. In the annexed figures:

FIG. 1 is a partial axial sectional view of an electric rotary machine, a bearing unit and a magnetic impulse ring according to the invention;

FIG. 2 is a schematic of the steps of a method to obtain a magnetic impulse ring according to the invention; and

FIGS. 3 to 6 show different embodiments of a tool to center a target ring in a magnetization device.

### DETAILED DESCRIPTION OF SOME EMBODIMENTS

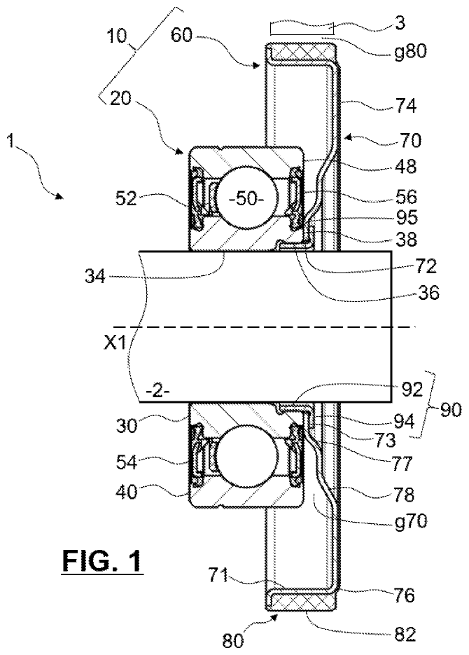

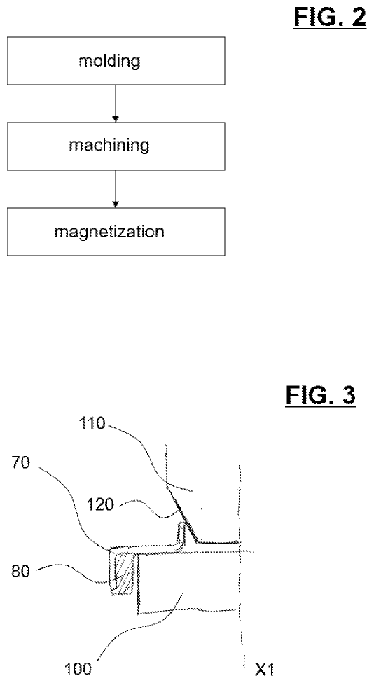

FIG. 1 illustrates a magnetic impulse ring 60, a bearing unit 10 and a rotary electrical machine 1 according to the invention.

The rotary electrical machine 1 can be a motor, a generator, or a starter-generator for a vehicle such as a passenger car.

The rotary electrical machine 1 comprises a rotor 2, a bearing unit 10 and magnetic detection means 3. The rotor 2, the bearing unit 10 and the magnetic impulse ring 60 are centered on a central axis X1 of the machine 1.

The rotary electrical machine 1 is designed to receive electrical power from a source of electrical energy such as a battery.

In a preferred embodiment, the machine is an electric motor, for an industrial or automotive application. For instance, the machine is an electric traction motor of a vehicle.

In another preferred embodiment of the invention, the rotary electrical machine is reversible, that is to say that it can produce electrical energy, and can advantageously restore some electrical energy to the power source or battery. For instance, the machine is a starter-alternator of a motor vehicle and forms part of a hybrid traction system together with an internal combustion engine.

The bearing unit 10 comprises a bearing 20 mounted on the rotor 2, and a magnetic impulse ring 60 mounted on the bearing 20. The magnetic detection means 3 are associated with the impulse ring 60 for tracking and/or controlling the rotational position of the rotor 2 around the axis X1.

The bearing 20 includes a rotating inner ring 30 and a non-rotating outer ring 40 centered on axis X1. The bearing 20 also comprises rolling elements 50, here balls, located between the inner ring 30 and the outer ring 40 and held in a cage 52. The inner ring 30 comprises a first cylindrical bore 34 and a second cylindrical bore 36. With reference to axis X1, the diameter of the bore 34 is smaller than the diameter of the bore 36. On the side of the bearing 20 where the magnetic impulse ring 60 is located, closer to the bore 36 than to the bore 34, rings 30 and 40 have annular lateral faces, respectively 38 and 48. The inner ring 30 is fixed on the rotor 2 which is fitted into bore 34. The inner ring 30 is fixed in rotation with the rotor 2. The outer ring 40 is mounted inside a stator (not illustrated) of the rotary electrical machine.

Preferably, each axial side of the bearing 20 comprises sealing means, respectively 54 and 56, located radially between the inner ring 30 and the outer ring 40. For example, the sealing means 54 and 56 are rubber seals comprising a base fixed on outer ring, a sealing lip in sliding contact with the inner ring, and a rigid insert located between the base and the lip. As another alternative, only one side of bearing 20 may comprise sealing means 54 or 56. As another alternative, sealing means 54 and/or 56 may have any suitable configuration.

The magnetic impulse ring 60 comprises a target holder 70 and a target 80 which is fixed to the target holder.

The magnetic impulse ring 60 is fixed in rotation with the rotor 2.

Going away from central axis X1, target holder 70 comprises an inner periphery 72, a radial portion 74 and an outer periphery 76. The inner periphery 72 defines an inner bore of the target holder 70.

In the preferred embodiment of the invention illustrated on FIG. 1, the magnetic impulse ring 60 is fixed to the rotating inner ring 30 of bearing 20 by means of a fixing sleeve 90. The fixing sleeve 90 comprises an axial portion and a radial portion. The axial portion of the fixing sleeve 90 in attached (for instance by interference fit or gluing) to the second cylindrical bore 36 of the inner ring 30, and the radial portion of the fixing sleeve holds tight the radial portion 74 of the target holder 70 against a lateral face 38 of the inner ring 30.

The radial portion 74 substantially radially extends from the inner periphery 72 towards the exterior of the bearing 20. The outer periphery 76 of the target holder 70 is located radially beyond the outer ring 40.

The radial portion 74 comprises frustoconical portions 77, 78 that are inclined in respect with central axis X1 towards the opposite direction to the bearing 20. A gap g70 is provided axially between the radial portion 74 of the target holder 70 and the lateral face 48 of the outer ring 40. Portions 77, 78 prevent any interference between the target holder 70 and the outer ring 40.

Alternatively, the target holder 70 may comprise shifting means of any alternate suitable shape, such as the one described in EP 2 870 373 A1.

In another preferred embodiment of the invention, not illustrated, the fixing sleeve 90 is integrally formed with the radial portion 74 of the target holder 70.

In another preferred embodiment of the invention, not illustrated, the magnetic impulse ring 60 is not attached to the bearing 20 but directly to the rotor 2.

The outer periphery 76 of the target holder 70 comprises an outer tubular portion 71 that axially extends from the radial portion 74. The outer tubular portion 71 extends parallel to axis X1 and is located radially above the outer ring 40 of the bearing 20.

The target 80 is held by the outer tubular portion 71 of target holder 70, beyond outer ring 40 radially to axis X1.

In the preferred embodiment of the invention illustrated on FIG. 1, the target 80 is radially outside the tubular portion 71.

In another preferred embodiment of the invention illustrated on FIG. 3, the target is radially inside the tubular portion 71.

Preferably, the target holder 70 is made from a ferromagnetic material such as SPPCC or SUS 430. Alternatively, the target holder 70 is made from a non-ferromagnetic steel or Aluminium.

Preferably, the target holder 70 is formed by stamping.

Alternatively, the target holder is made from a synthetic material such as a plastic or a composite material and is formed by molding.

The target is obtained from a magnetizable material.

Advantageously, the target 80 comprises anilco or ferrite or rare earth such as NdFeB or SmFeN powder embedded in a matrix of resin or plastic or rubber material. Advantageously, the target is entirely made of anilco or ferrite or NdFeB or SmFeN powder embedded in a matrix of resin or plastic or rubber material.

The target 80 has a plurality of alternating South and North magnetic poles. The target 80 has an outer surface 82 that radially faces the magnetic detection means 3. The target 80 and the magnetic detection means 3 cooperate for tracking the rotation of the impulse ring 60, target holder 70, shaft 2 around central axis X1. A gap g80 is provided radially between the outer surface 82 and the detection means 3. In other words, the target 80 of the magnetic impulse ring 60 is a radial target.

As an alternative, the magnetic impulse ring may have an axial target, with a gap defined axially between the target and the magnetic detection means. In this case, the outer periphery 76 of target holder 70 is specifically adapted.

The magnetic detection means are sensitive to the changes of magnetic field generated by the magnetic poles of the target, and generate an electric signal representative of these changes.

Preferably, the magnetic detection means 3 comprise at least one Hall effect cell or a Magneto-resistive cell.

The magnetic impulse ring (60) has a Total Pitch Deviation (TPD) smaller than or equal to 0.5%.

Such a magnetic impulse ring 60 is obtained according to a method which will now be described.

At first, the target holder 70, which is annular and made from a metallic magnetic material, is formed by a plastic deformation process, preferably by stamping. Its relatively low thickness, comprised between 0.5 mm and 2 mm, allows to use such a process.

A magnetizable material is molded according to a desired shape onto the target holder. Once cooled down, this magnetizable material constitutes the target. A target ring, with a more or less cylindrical outer radial surface, is thus obtained.

In a second step, some material is then removed from the outer radial surface of the target ring, in order to obtain a better circular form. For instance, the outer radial surface is machined with a grinding tool. A circle with a circularity of 0.05 mm at max is obtained. This machining step allows to improve the circularity of the outer diameter of the target ring due to the manufacturing tolerances during the manufacturing of the target ring, in particular the molding phase.

In a successive step, the magnetizable material of the target of the target ring is magnetized, in such a way as to form alternating South and North magnetic poles as regularly as possible. The target ring is placed in a tool of a magnetization device. The tool comprises a mandrel (not illustrated) rotatable around an axis X1, a support 130, a magnetizing yoke 100 and a jig 110. The target ring is render fixed in rotation with the mandrel thanks to the support and the jig. During the magnetization, the target ring is hold tight on the mandrel, between the support and the jig.

The South and North magnetic poles are successively formed in the target ring by a magnetization head (not illustrated) of the magnetizing yoke upon rotation of the target ring together with the mandrel.

During the installation of the target ring in the magnetization device, the support is first placed in the tool, then the target ring is introduced in the tool until it rests against the support. The jig is then introduced in the tool until it reaches the target ring. Moreover, in order to ensure a more accurate positioning and centering of the target ring with respect to the axis of rotation X1 of the mandrel, the jig has a tapered annular surface 120 which, by contact with the target ring, centers accurately the target ring onto the rotation axis of the mandrel X1.

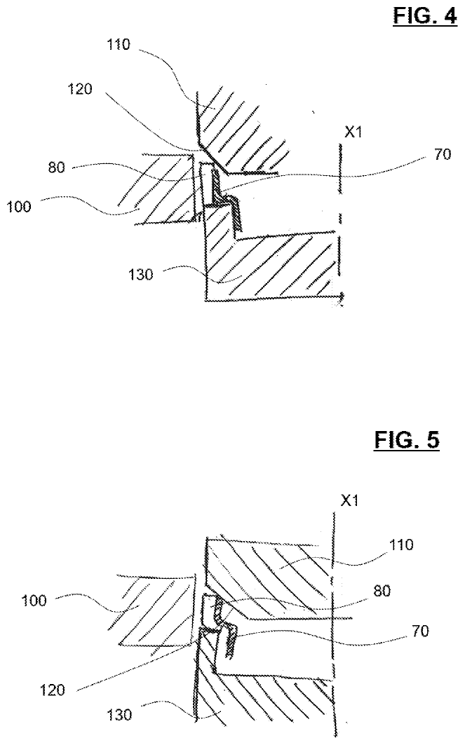

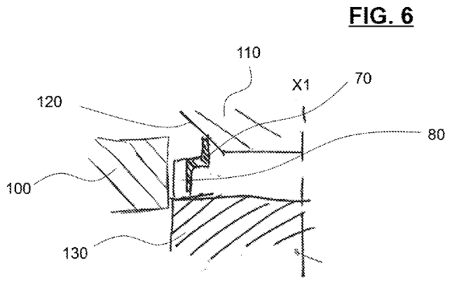

FIGS. 3 to 6 illustrate several preferred embodiments of a magnetic impulse ring according to the inventions and several different configurations of the tool of the magnetization device according to the invention. For the embodiment of FIG. 3, the support is fixed to or integrally formed with the yoke, whereas for the embodiments of FIGS. 4 to 6, the support and the yoke are distinct.

By improving the centering of the target ring on the rotation axis of the mandrel, the magnetization of the target is done more accurately, in such a way that the Single Pitch Deviation of the formed magnetic poles is reduced, as well as the Total Pitch Deviation of the magnetic impulse ring.

The inventors have observed that the magnetic impulse ring obtained according to the invention has a Total Pitch Deviation (TPD) which is smaller than or equal to 0.5%. This excellent result allows to better measure the rotational position of the impulse ring and to better control the rotation of the rotor. The life of the battery connected to the rotary electrical machine is made longer, and the CO2 emissions of the internal combustion engine are reduced.

1. A magnetic impulse ring having a central axis and comprising:
a target holder, and
a target that is fixed to the target holder, the target comprising a plurality of alternating South and North magnetic poles and being adapted to cooperate with magnetic detection means for tracking the rotation of the magnetic impulse ring around its central axis, wherein
the Total Pitch Deviation (TPD) of the magnetic impulse ring is less than or equal to 0.5%.

2. The magnetic impulse ring according to claim 1, wherein the target comprises anilco or ferrite or rare earth powder embedded in a matrix of resin or plastic or rubber material.

3. The magnetic impulse ring according to claim 1, wherein the target holder is made from a ferromagnetic material such as SPPCC or SUS 430.

4. A bearing unit comprising:
an inner ring,
an outer ring, and
a magnetic impulse ring having;
a central axis,
a target holder, and
a target that is fixed to the target holder, the target comprising a plurality of alternating South and North magnetic poles and being adapted to cooperate with magnetic detection means for tracking the rotation of the magnetic impulse ring around its central axis, wherein
the Total Pitch Deviation (TPD) of the magnetic impulse ring is less than or equal to 0.5%, and
the inner and outer rings being centered on the central axis of the magnetic impulse ring which is fixed in rotation with the inner ring or the outer ring.

5. The bearing unit according to claim 4, wherein at least one row of rolling elements is arranged between the inner and outer rings.

6. The bearing unit according to claim 4, wherein the target holder comprises an outer tubular portion, which extends parallel to the central axis of the impulse ring and located radially above the outer ring of the bearing, the magnetic impulse ring being fixed in rotation with the inner ring.

7. A rotary electrical machine comprising:
a stator,
a rotor,
magnetic detection means, and
a magnetic impulse ring having;
a central axis,
a target holder, and
a target that is fixed to the target holder, the target comprising a plurality of alternating South and North magnetic poles and being adapted to cooperate with magnetic detection means for tracking the rotation of the magnetic impulse ring around its central axis, wherein
the Total Pitch Deviation (TPD) of the magnetic impulse ring is less than or equal to 0.5%, and
the impulse ring being fixed in rotation with the rotor, the magnetic detection means being associated with the magnetic impulse ring for tracking the rotation of the rotor, the magnetic impulse ring being used to control the rotational position of the rotor with respect to the stator.

8. The rotary electrical machine according to claim 7, further comprises a bearing or supporting in rotation the rotor with respect to the stator, the bearing comprising an inner ring and an outer ring, the magnetic impulse ring being fixed in rotation with the inner ring or the outer ring of the bearing.

9. A method of obtaining a magnetic impulse ring, the method comprising the steps of:
molding a target made from magnetizable material on a target holder to obtain a target ring,
machining an outer diameter of the target ring in order to improve the circularity of the outer diameter with respect to the central axis,
magnetizing the target ring with a magnetization device to form a plurality of magnetic poles pairs formed in the target.

10. The method according to claim 9, wherein the magnetization device provides a tool comprising a mandrel rotatable around an axis, a magnetizing yoke, a support and a jig, the target ring being held tight between the support and the jig during magnetization, and the jig has a tapered annular surface which, by contact with the target ring, accurately centers the target ring onto the rotation axis of the mandrel.
